(19) United States
(12) Patent Application Publication
(10) Pub. No.: US 2005/0262527 A1
(43) Pub. Date: Nov. 24, 2005

(54) Information processing apparatus and information processing method

(75) Inventors: Hideto Yuzawa, Kanagawa (JP); Kengo Omura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/109,712

(22) Filed: Apr. 20, 2005

(30) Foreign Application Priority Data
Apr. 22, 2004 (JP) 2004-127444
Apr. 19, 2005 (JP) 2005-120748

(51) Int. Cl. H04N 7/16; H04N 7/14; H04N 7/10; H04H 9/00; H04N 5/225; H04N 7/025

(52) U.S. Cl. 725/10; 725/12; 725/34; 348/14.01

(57) ABSTRACT

An information processing apparatus includes an estimate portion and an append portion. The estimate portion that estimates states of mind of a person with either or both of living body information and sound information of the person acquired at a time of capturing the person, and the append portion that appends an index to image information acquired at the time of capturing the person with the states of mind of the person estimated by the estimate portion.

### BACKGROUND OF THE INVENTION

1. Field of the Invention

This invention relates to an information processing apparatus and information processing method.

2. Description of the Related Art

Multiple conferences are held every hour almost every day. Data is acquired on every conference, thus acquired enormous amount of data on the conferences are stored, and the amount of data is increasing day by day. Under the circumstances, there arise problems in that it is troublesome and it takes time to designate a desired conference and find a desired point (scene) from the data on the conferences, in order to review decisions made on the conference or reuse the data on the conference. It is basically difficult or impossible to find the desired scene, in some cases.

Conventionally, the decisions made on the conference can be reviewed by reading the minutes issued after the conference. The detailed process or background to come to the decision, however, is not documented, and accordingly the process cannot be reviewed. Also, even if the content is not included in the main subject or listed in the minutes, there are some cases that the person involved in the content likes to review or remember the important content such as the content of speech, the content of the document, or the like.

A method of utilizing moving images can be stated as a technique for supporting the above-mentioned review. That is, the conference is recorded with a camcorder so that remembering can be aided by playing the desired scene later. The technique of searching the desired scene promptly is demanded to play the desired scene.

Conventional techniques, however, it is difficult to identify the desired scene from the scenes separated at given intervals. It is also difficult to identify the desired scene while changing the scenes, because meaningless scenes for a viewer are also included. It is difficult to judge an interest level in the conference or presentation from the rate of gazing at the slides. Besides, it is difficult to identify an important scene for the viewer who does not say a word, when the voice volume of the speaker is used to determine an importance level. In short, the conventional techniques cannot meet the demands for the desired scenes relative to the respective viewers of the conference. In conclusion, it is difficult for the viewer to review the desired scene effectively with the conventional techniques.

### SUMMARY OF THE INVENTION

The present invention has been made in view of the above circumstances and provides an information processing apparatus, information processing method, and storage medium readable by a computer.

According to one aspect of the present invention, there is provided an information processing apparatus including an estimate portion that estimates states of mind of a person with either or both of living body information and sound information of the person acquired at a time of capturing the person; and an append portion that appends an index to image information acquired at the time of capturing the person with the states of mind of the person estimated by the estimate portion. According to the present invention, the state of mind of the person can be appended to the image information at the time of capturing as an index, and accordingly the desired scene can be reviewed later in an effective manner.

According to another aspect of the present invention, there is provided an information processing method including estimating states of mind of a person with either or both of living body information and sound information of the person acquired at a time of capturing the person; and appending an index to image information acquired at the time of capturing the person with the states of mind of the person estimated by the estimate portion. According to the present invention, the state of mind of the person can be appended to the image information at the time of capturing as an index, and accordingly the desired scene can be reviewed later in an effective manner.

### BRIEF DESCRIPTION OF THE DRAWINGS

Embodiments of the present invention will be described in detail based on the following figures, wherein:

FIG. 1 is a block diagram of an information processing system according to a first embodiment;

FIG. 2 shows a datasheet in a living body information storage portion;

FIG. 3 shows a datasheet in a sound information storage portion;

FIG. 4 shows a datasheet in a conference image storage portion;

FIG. 5 shows a datasheet in a conference information storage portion;

FIG. 6 shows an index file in an index file storage portion;

FIG. 7 is a display example displayed by a display controller;

FIG. 8 shows another display example displayed by the display controller;

FIG. 9 shows still another display example displayed by the display controller;

FIG. 10 shows yet another display example displayed by the display controller;

FIG. 11 is a view illustrating how to detect and store living body information, sound information, and conference image information;

FIG. 12 is a flowchart showing a landmark scene selection process of the first embodiment;

FIG. 13 is a block diagram of the information processing system according to a second embodiment;

FIG. 14 shows a graphical user interface provided by a state information input portion;

FIG. 15 shows an index file in an index file storage portion;

FIG. 16 is further another display example displayed by a display controller; and

FIG. 17 is a flowchart showing the landmark scene selection process according to the second embodiment.

### DESCRIPTION OF THE EMBODIMENTS

A description will now be given, with reference to the accompanying drawings, of embodiments of the present invention.

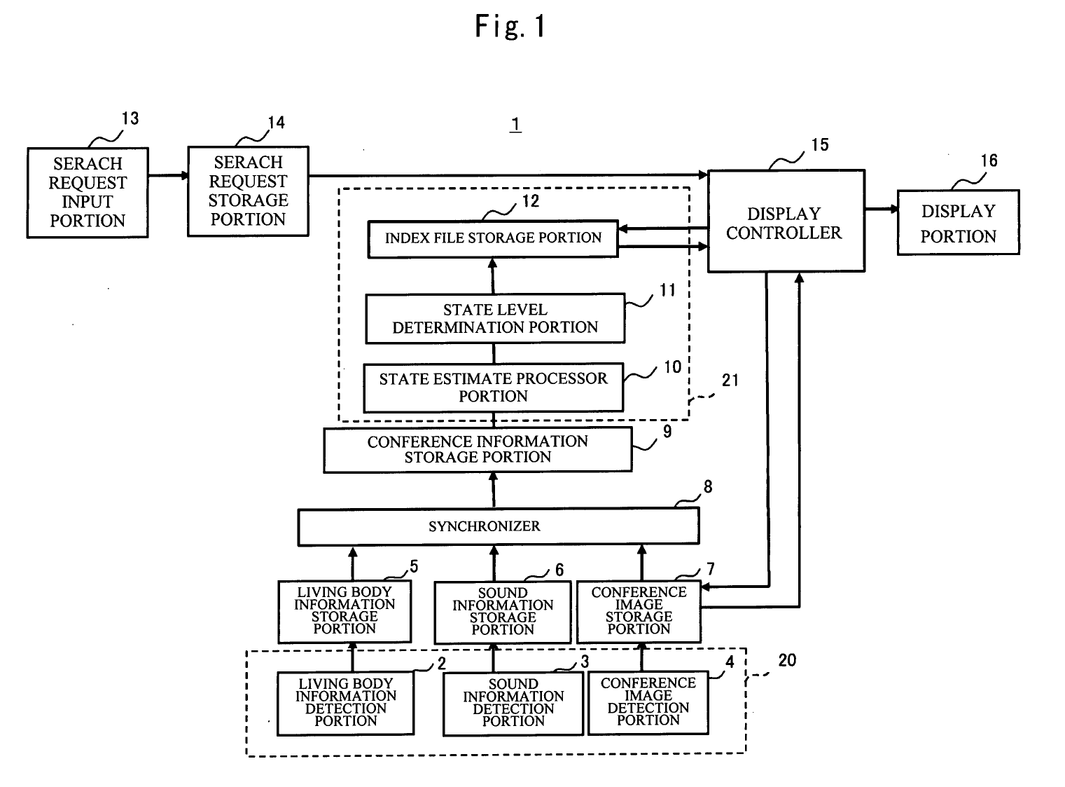

First, a description will now be given of a first embodiment. FIG. 1 is a block diagram of an information processing system 1 of the present embodiment. As shown in FIG. 1, the information processing system 1 includes a living body information detection portion 2, a sound information detection portion 3, a conference image detection portion 4, a living body information storage portion 5, a sound information storage portion 6, a conference image storage portion 7, a synchronizer 8, a conference information storage portion 9, a state estimate processor 10, a state level determination portion 11, an index file storage portion 12, a search request input portion 13, a search request storage portion 14, a display controller 15, and a display portion 16. The living body information detection portion 2, the sound information detection portion 3, and the conference image detection portion 4 serve as a conference information detection portion 20. The state estimate processor 10, the state level determination portion 11, and the index file storage portion 12 serve as a landmark selection processor 21 that performs selection process of the landmark.

The information processing system 1 is used for detecting and storing the content of the conference together with the living body information, the sound information, and conference image information, estimating or speculating psychological states of mind or moods of a person from the stored information, and providing the states of mind to the moving image as an index. This allows a user to search for the stored content of the conference with a clue.

The living body information detection portion 2 is composed of a camera, an image processor, and the like, and is used for detecting the living body information of the person. Here, the living body information of the person includes information on an eye of a conference viewer, a brain wave, a temperature on skin of face, and the like. The information on the eye of the conference viewer includes a blink, a pupil diameter, a target being gazed at, and a gazing period. The information on the blink and the pupil diameter can be acquired by extracting a face area from the captured image of the viewer's face, specifying an eye area, counting the number of blinks, and measuring the pupil diameter. The target being gazed at and the gazing period can be acquired by the image captured with the camera set on the side of the target being gazed at. The eye area is specified in the above-mentioned manner, the target being gazed at is specified from the position of the camera that has captured the image, and the gazing period can be acquired with the period of capturing the eye area. The temperatures on skin of face can be acquired by an infrared camera, thermography, or the like, and therefore, the viewer does not have to wear a measuring instrument. Here, the living body information is related to the information that can be acquired without making the conference viewer wear the measuring instrument.

The sound information detection portion 3 is composed of a sound colleting microphone, for example, to detect voices and sounds of the viewers or speakers at the conference. The conference image detection portion 4 is composed of a camcorder or the like to detect the conference image. The conference image detection portion 4 may employ a camera that can take the presentation documents used in the conference or the viewers at wide angle. The above-mentioned living body information detection portion 2, the sound information detection portion 3, and the conference image detection portion 4 are located on given positions in the conference room. While the conference image detection portion 4 is capturing the conference images, the living body information detection portion 2 and the sound information detection portion 3 detect the living body information and the sound information.

The living body information storage portion 5 stores the living body information detected by the living body information detection portion 2 in data sheet format. The sound information storage portion 6 stores the sound information detected by the sound information detection portion 3 in the datasheet format. The conference image storage portion 7 stores the conference images detected by the conference image detection portion 4 in datasheet format showing a list.

The synchronizer 8 synchronizes the living information of the human living body stored in the living body information storage portion 5 and the sound information stored in the sound information storage portion 6 with the image information stored in the conference image storage portion 7. The conference information storage portion 9 retains the information synchronized in the synchronizer 8 as an index file.

The state estimate processor 10 uses at least one of the human living body information and the sound information obtained while the person is being captured in order to estimate or speculate the states of mind of the person. An index is appended to the image information that has been captured with the use of the estimated states of mind of the person. More specifically, the state estimate processor 10 performs a process of estimating the states of mind of the viewer, with the data included in a conference information index file as a parameter and with a given evaluation function. The state estimate processor 10 performs a given program to fulfill the function thereof. The states of mind of the viewer includes, for example, a cognitive state, psychological information, or the like of the conference viewer.

The states of mind of the viewer includes, for example, the interest level that represents the degree to which a person is interested in a thing, an excitation level that represents the degree to which emotions of the person get excited, a comfort level that represents the degree to which the person feels relaxed and comfortable, an understand level that represents the degree to which the person can realize and understand the principle of the thing, a remember level that represents the degree to which the person does not forget and remembers the thing, a concentration level of the person, a support level that represents the degree to which the person agrees with the other's opinion, a shared feeling level that represents the degree to which the person feels and understands the other's opinion in the same manner, a subjectivity level that represents the degree to which the person evaluates on the basis of subjectivity of the person, an objectivity level that represents the degree to which the person shows universal points of view, being independent of a specific, personal, and subjective way of thinking, a dislike level that represents the degree to which the person's mind has a negative feeling, and a fatigue level that represents the degree to which the person is tired. The evaluation function is to weight and add the living body information of the viewer (participant) and the sound information obtained while the viewer (participant) is being captured.

According to the psychology of eye movement (the experimental psychology of eye movement, the psychology of blink, and the psychology of pupillary movement), the interest relates to the pupil diameter, the understand level and remember level relate to the blinks, the excitation level and the comfort level relate to the blinks and the temperatures on skin of face. The accuracy, however, cannot be maintained by employing only one of the above-mentioned levels, because the temperature on skin of face rises due to the temperature environment in the conference room, for example. Therefore, the state estimate processor 10 calculates a state estimate value with the evaluation function to which the data, a speech sound volume, and an environmental sound are weighted and added in order to specify the psychological states of the conference viewer.

The state level determination portion 11 determines priority levels of a person's states of mind estimated by the state estimate processor 10. More particularly, the state level determination portion 11 ranks the above-mentioned levels in the states of mind of the viewer on the basis of the state estimate value estimated by the state estimate processor 10. This can reduce the number of estimation results of the state estimate processor 10 referred to by the display controller 15. The estimation results are reduced to the number of scenes appropriate as the landmarks, and thereby preventing the search performance from drastically degrading owing to the enormous numbers of items to be searched. The state level determination portion 11 stores thus ranked viewer's states of mind together with the time information of the conference image in the index file storage portion 12. The index file storage portion 12 retains the index file in table format for each viewer.

The search request input portion 13 is composed of a touch panel, mouse, keyboard, or the like. A user is able to designate a specific viewer with the search request input portion 13 and further designate the viewer's states of mind such as the viewer's interest. The search request storage portion 14 stores the search conditions input from the search request input portion 13.

The display controller 15 refers to the index appended by the state estimate processor 10. More particularly, the display controller 15 refers to the index file storage portion 12 and obtains the data in the index file. The display controller 15 refers to the conference image storage portion 7 on the basis of thus obtained data in the index file, obtains the conference image information, and generates an image thumbnail. The display portion 16 performs a display process based on the information of the display controller 15. Each of the above-mentioned storage portions is composed of a storage apparatus such as a memory, hard disc, flexible disc, or the like.

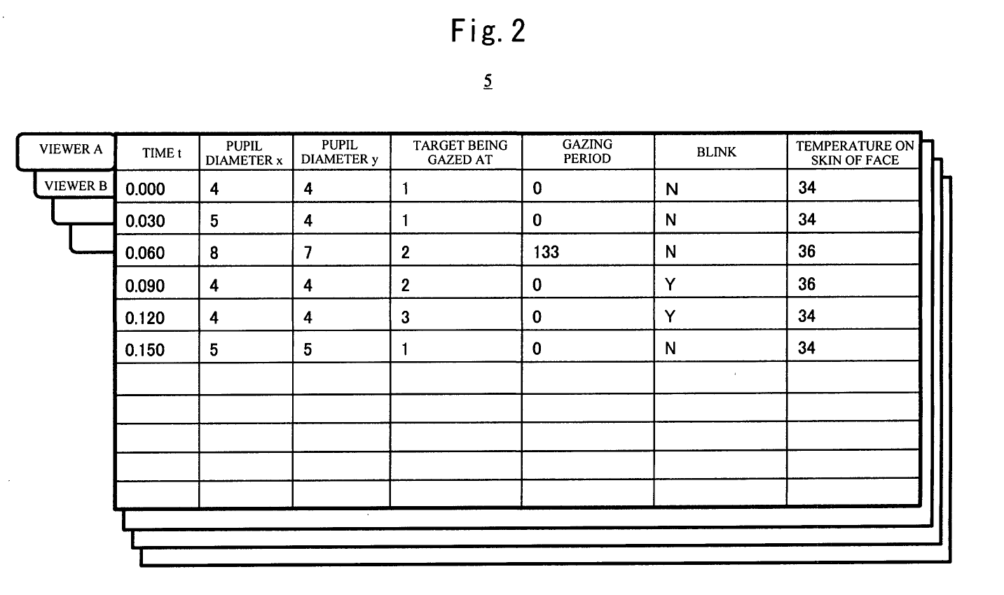

FIG. 2 shows a datasheet in the living body information storage portion 5. Referring to FIG. 2, each datasheet corresponds to each viewer and a time t, and includes the living body information such as pupil diameters x and y, the target being gazed at, the gazing period, the blink, and the temperature on skin of face. Especially, the target being gazed at is identified by specifying a camera position, set on the side of the target being gazed at, which can be taken by another camera. Also, the gazing periods for gazing at each target are accumulated and stored. A method for expressing the living body information may not be limited to the above-mentioned datasheet, and may have variations such as graphs.

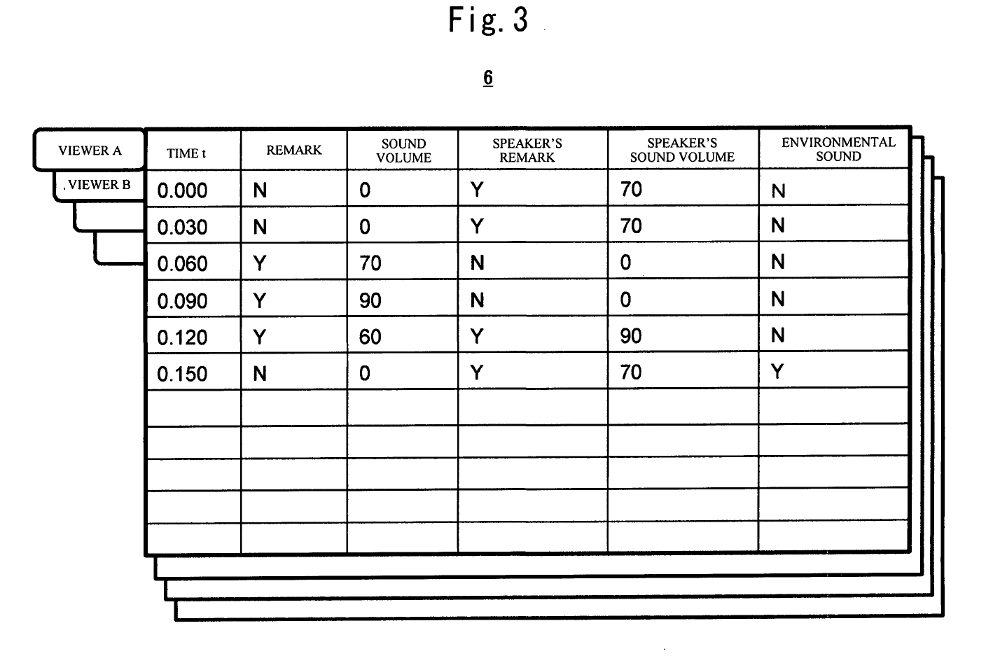

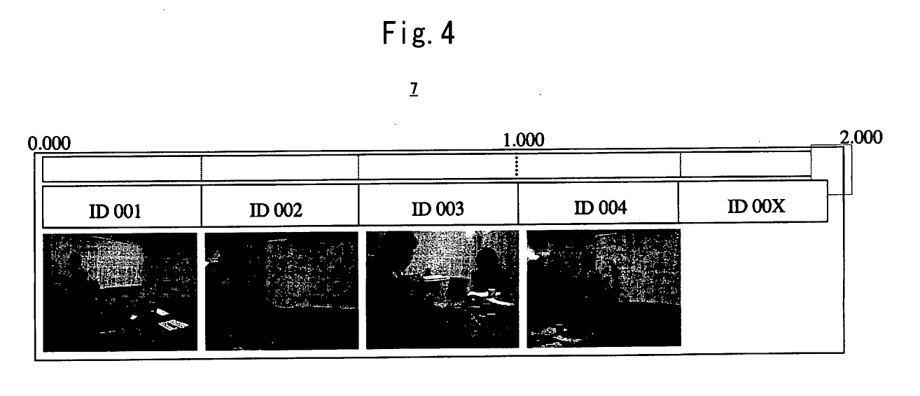

FIG. 3 shows a datasheet in the sound information storage portion 6. Referring to FIG. 3, the sound information includes whether or not there is a remark, the sound volume, whether or not the speaker makes a remark, the voice volume of the speaker, and the environmental sound. The sound information is stored for each viewer to correspond to the time t. Especially, the environmental sound includes the voice information created together with the image. A method for expressing the sound information may not be limited to the above-mentioned datasheet, and may have variations such as graphs. FIG. 4 shows a datasheet in the conference image storage portion 7. As shown in FIG. 4, the conference image is stored to correspond to an identification number ID.

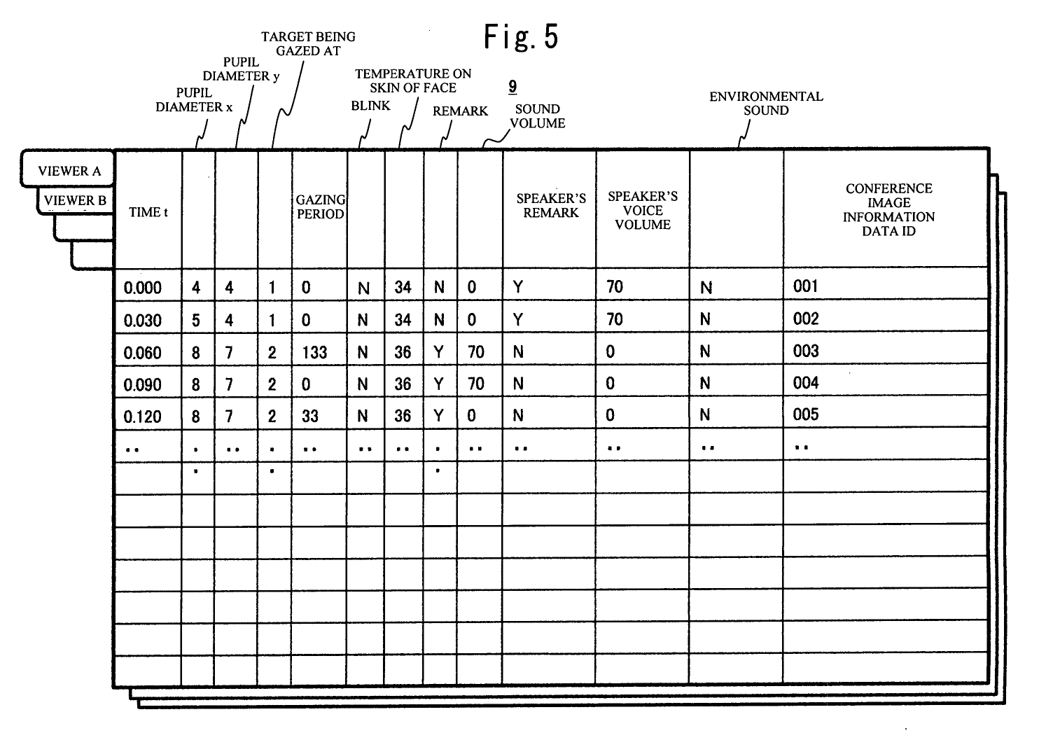

FIG. 5 shows a datasheet in the conference information storage portion 9. Referring to FIG. 5, the conference information retains the living body information, the sound information, and a conference image information data ID to correspond to the time information, while the living body information includes the pupil diameters, the target being gazed at, the gazing period, the blink, and the temperature on skin of face, and the sound information includes whether or not the speaker makes a remark, the voice volume of the speaker, and the environmental sound, as described above.

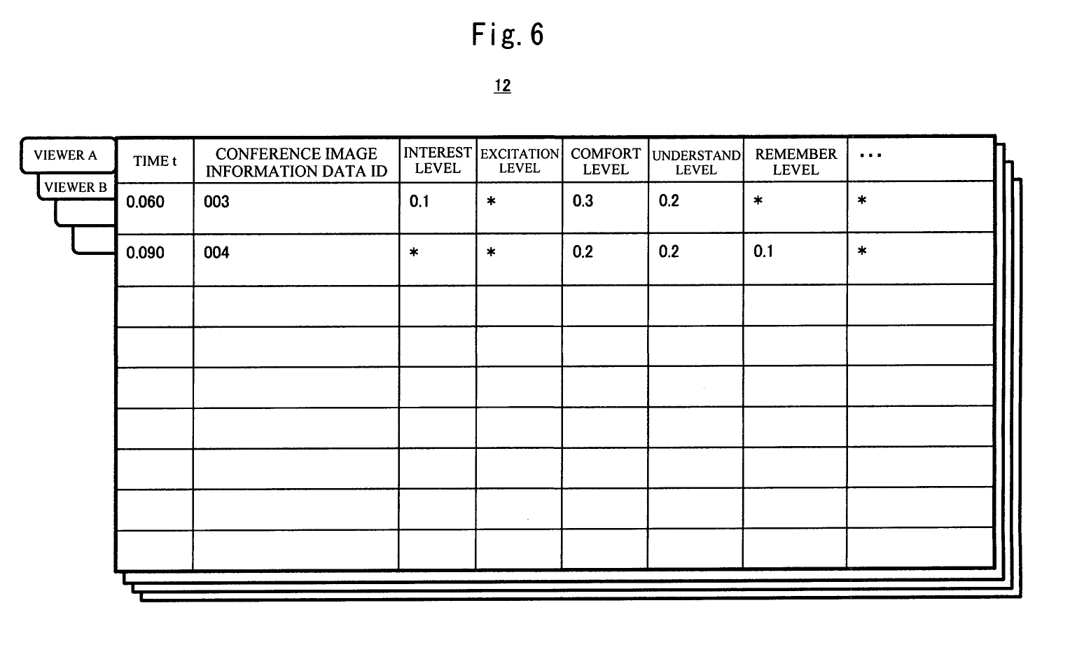

FIG. 6 shows the index file in the index file storage portion 12. Referring to FIG. 6, there are provided, from the left, the time t, the conference image information ID, items representing the viewer's states of mind such as the interest level, the excitation level, the comfort level, the understand level, and the remember level. The times respectively corresponding to the conference image information are input into the columns of the time t. The numbers that identify the conference image information are input into the cells of the conference image information ID. The state estimate values obtained from the above-mentioned evaluation function are input into the respective columns of the viewer's states of mind such as the interest level, the excitation level, the comfort level, the understand level, and the remember level. In addition, * marks in the drawing are the scenes deleted by the state level determination portion 11. Thus, the number of the scenes to be searched can be reduced. In this manner, the image information IDs, to which indexes such as the interest level, the excitation level, the comfort level, and the understand level are appended, are stored in the index file storage portion 12. In addition, the indexes such as the interest level, the excitation level, the comfort level, and the understand level are stored to correspond to the time information t of the image information. Here, the interest level, the excitation level, the comfort level, and the understand level are shown as the viewer's states of mind, yet the viewer's states of mind may not be limited to the above-mentioned levels, and may have variations.

Next, the evaluation function is described in the following expressions (1) through (11) so as to calculate the state estimate values of the interest level, the excitation level, the comfort level, the understand level, the remember level, the support level, the shared feeling level, the subjectivity level, the objectivity level, the dislike level, and the fatigue level of the person.

An interest level f1=w11*the pupil diameters (change amount, change speed)+w12*the gazing (period, times)+w13*blinks (rate, the number, the number of continuing blinks)+w14*the change amount of the temperatures on skin of face+w15*the sound volume of the remark+w16*the voice volume of the speaker's remark+w16*the environmental sound . . . (1)

An excitation level f2=w21*the pupil diameters (change amount, change speed)+w22*the gazing (period, times)+w23*blinks (rate, the number, the number of continuing blinks)+w24*the change amount of the temperatures on skin of face+w25*the sound volume of the remark+w26*the voice volume of the speaker's remark+w26*the environmental sound . . . (2)

A comfort level f3=w31*the pupil diameters (change amount, change speed)+w32*the gazing (period, times)+w33*blinks (rate, the number, the number of continuing blinks)+w34*the change amount of the temperatures on skin of face+w35*the sound volume of the remark+w36*the voice volume of the speaker's remark+w36*the environmental sound . . . (3)

An understand level f4=w41*the pupil diameters (change amount, change speed)+w42*the gazing (period, times)+w43*blinks (rate, the number, the number of continuing blinks)+w44*the change amount of the temperatures on skin of face+w45*the sound volume of the remark+w46*the voice volume of the speaker's remark+w46*the environmental sound . . . (4)

A remember level f5=w51*the pupil diameters (change amount, change speed)+w52*the gazing (period, times)+w53*blinks (rate, the number, the number of continuing blinks)+w54*the change amount of the temperatures on skin of face+w55*the sound volume of the remark+w56*the voice volume of the speaker's remark+w56*the environmental sound . . . (5)

A concentration level f6=w61*the pupil diameters (change amount, change speed)+w62*the gazing (period, times)+w63*blinks (rate, the number, the number of continuing blinks)+w64*the change amount of the temperatures on skin of face+w65*the sound volume of the remark+w66*the voice volume of the speaker's remark+w66*the environmental sound+w67*the brain waves (frequency) . . . (6)

A support level f7=w71*the pupil diameters (change amount, change speed)+w72*the gazing (period, times)+w73*blinks (rate, the number, the number of continuing blinks)+w74*the change amount of the temperatures on skin of face+w75*the sound volume of the remark+w76*the voice volume of the speaker's remark+w76*the environmental sound+w77*the brain waves (frequency) . . . (7)

A shared feeling level f8=w81*the pupil diameters (change amount, change speed)+w82*the gazing (period, times)+w83*blinks (rate, the number, the number of continuing blinks)+w84*the change amount of the temperatures on skin of face+w85*the sound volume of the remark+w86*the voice volume of the speaker's remark+w86*the environmental sound+w87*the brain waves (frequency) . . . (8)

A subjectivity level f9=w91*the pupil diameters (change amount, change speed)+w92*the gazing (period, times)+w93*blinks (rate, the number, the number of continuing blinks)+w94*the change amount of the temperatures on skin of face+w95*the sound volume of the remark+w96*the voice volume of the speaker's remark+w96*the environmental sound+w97*the brain waves (frequency) . . . (9)

An objectivity level f10=w101*the pupil diameters (change amount, change speed)+w102*the gazing (period, times)+w103*blinks (rate, the number, the number of continuing blinks)+w104*the change amount of the temperatures on skin of face+w105*the sound volume of the remark+w106*the voice volume of the speaker's remark+w106*the environmental sound+w107*the brain waves (frequency) . . . (10)

A fatigue level f11=w111*the pupil diameters (change amount, change speed)+w112*the gazing (period, times)+w113*blinks (rate, the number, the number of continuing blinks)+w114*the change amount of the temperatures on skin of face+w115*the sound volume of the remark+w116*the voice volume of the speaker's remark+w116*the environmental sound+w117*the brain waves (frequency) . . . (11)

A description will be given of the above-mentioned expressions in detail. The interest level f1 in the expression (1) is capable of identifying an image as a scene of interest, in which the pupils are significantly changed, the gazing period is long, the number of blinks is small, the temperatures of skin of face greatly change, and the sound volume of the remark is big. The interest level f1 in the expression (1) can be calculated by respectively weighting with weighting factors w11 through w1n and adding the pupil diameters (change amount, change speed), the gazing (period, times), blinks (rate, the number, the number of continuing blinks), the change amount of the temperatures on skin of face, the sound volume of the remark, the voice volume of the speaker's remark, and the environmental sound.

The excitation level f2 in the expression (2) can be calculated by respectively weighting with weighting factors w21 through w2n and adding the pupil diameters (change amount, change speed), the gazing (period, times), blinks (rate, the number, the number of continuing blinks), the change amount of the temperatures on skin of face, the sound volume of the remark, the voice volume of the speaker's remark, and the environmental sound. The comfort level f3 in the expression (3) can be calculated by respectively weighting with weighting factors w31 through w3n and adding the pupil diameters (change amount, change speed), the gazing (period, times), blinks (rate, the number, the number of continuing blinks), the change amount of the temperatures on skin of face, the sound volume of the remark, the voice volume of the speaker's remark, and the environmental sound.

In the understand level f4 in the expression (4), it is considered that the number of blinks is increased in the case where it is difficult to understand (according to the psychology of blinks). Generally, if it is difficult for the viewer to understand, the viewer tries to get supplementary information and the gazing period tends to increase. Therefore, the image having a long gazing period and many times of blinks is specified as the scene difficult to understand. The understand level f4 in the expression (4) can be calculated by respectively weighting with weighting factors w41 through w4n and adding the pupil diameters (change amount, change speed), the gazing (period, times), blinks (rate, the number, the number of continuing blinks), the change amount of the temperatures on skin of face, the sound volume of the remark, the voice volume of the speaker's remark, and the environmental sound.

The remember level f5 in the expression (5) can be calculated by respectively weighting with weighting factors w51 through w5n and adding the pupil diameters (change amount, change speed), the gazing (period, times), blinks (rate, the number, the number of continuing blinks), the change amount of the temperatures on skin of face, the sound volume of the remark, the voice volume of the speaker's remark, and the environmental sound.

In the concentration level f6, for example, when the change amount of the pupils is large, the gazing period is long, the number of the blinks is small, the change amount of the temperatures on skin of face is large, and the sound volume of the remark is big, there is a high possibility that the viewer is focusing on his or her attention. This is used for specifying the psychological states of the viewer. The concentration level f6 in the expression (6) can be calculated by respectively weighting with weighting factors w61 through w6n and adding the pupil diameters (change amount, change speed), the gazing (period, times), blinks (rate, the number, the number of continuing blinks), the change amount of the temperatures on skin of face, the sound volume of the remark, the voice volume of the speaker's remark, the environmental sound, and the brain waves. In the same manner, the psychological states of the viewer can be identified in other expressions.

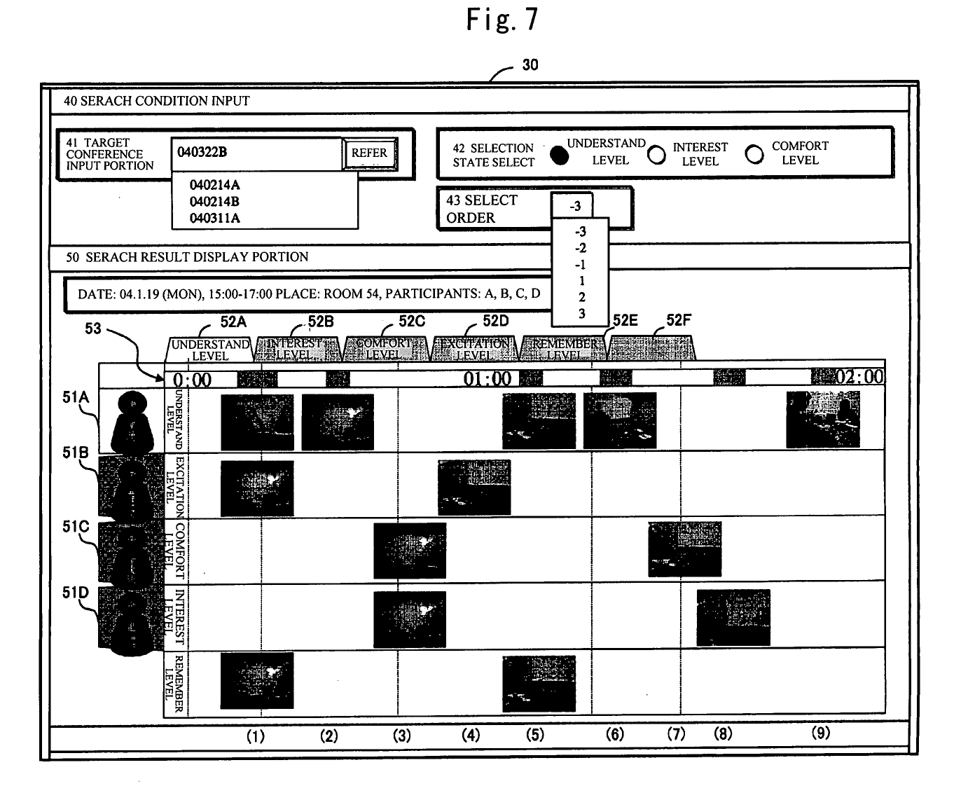

FIG. 7 is a display example displayed by the display controller 15. Referring to FIG. 7, the display controller 15 displays a graphical user interface 30 including a search condition input portion 40 and a search result display portion 50 on the display portion 16. FIG. 7 shows only the understand level, the interest level, and the comfort level in the viewer's states of mind. The search condition input portion 40 includes a target conference input portion 41, a selection state select portion 42, and a selection order select portion 43. A search request can be input into the target conference input portion 41, the selection state select portion 42, and the selection order select portion 43, with the search request input portion 13. Arbitrary conference image can be selected with the target conference input portion 41. The viewer's states of mind can be selected with the selection state select portion 42. The number of the scenes selected by the state level determination portion 11 can be determined with the selection order select portion 43.

Also as shown in FIG. 7, the display controller 15 displays the thumbnails on the search result display portion 50 in table format. The display controller 15 is capable of displaying the thumbnails for every viewer included in the conference image information on the search result display portion 50. Here, the thumbnails are displayed based on the states of mind of a viewer A. The display controller 15 displays viewer tabs (selection means) 51A through 51D on the search result display portion 50 to show the thumbnails for every person. The display controller 15 displays status tabs 52A through 52F to show the thumbnails for each state of mind. It is thus possible to view landmark slides related to all states of mind of, for example, a viewer A.

The display controller 15 also displays a timeline slider 53 in the search result display portion 50. With the timeline slider 53, the times can be changed at short intervals. Moreover, if a thumbnail is clicked, the display controller 15 plays the image information of the selected thumbnail and subsequent image information. It is therefore possible to know that the viewer A understands the content of the conference at the points of (1), (2), (5), (6), and (9) in FIG. 7.

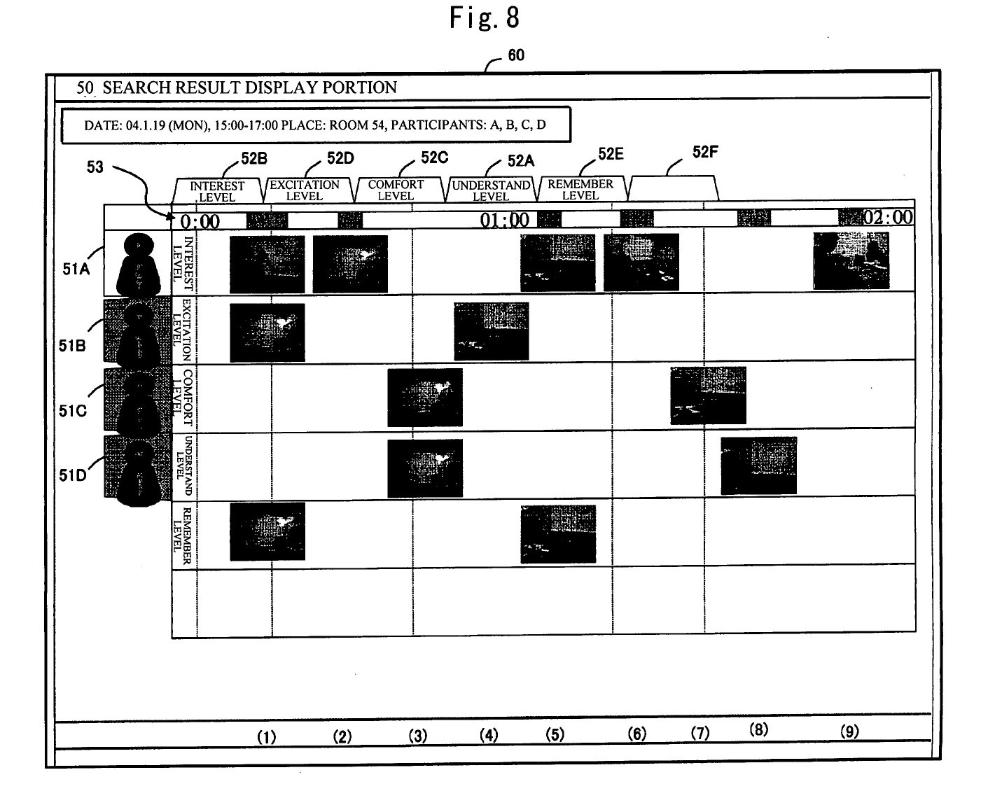

Next, a description will be given of another display example. FIG. 8 shows another display example. Referring to FIG. 8, the display controller 15 displays a graphical user interface 60 including the search result display portion 50 on the display portion 16. The display controller 15 displays the thumbnails on the search result display portion 50 in table format. The thumbnails can be displayed for every viewer included in the conference image information on the search result display portion 50. Here, the thumbnails are displayed based on the states of mind of the viewer A.

The display controller 15 displays the viewer tabs 51A through 51D on the search result display portion 50 to show the thumbnails for each person. It is thus possible to view the landmark slides related to the interest level of viewers A through D. In addition, the display controller 15 displays the status tabs 52A through 52F to show the thumbnails for each state of mind. The display controller 15 displays the timeline slider 53 on the search result display portion 50. The search result display portion 50 displays the thumbnails related to the interest level, the excitation level, the comfort level, the understand level, and the remember level at a time.

Referring to FIG. 8, it is possible to know that the viewer A is interested in the content of the conference, is excited, and has a good remembering at the point of (1). The viewer A is interested in the content of the conference, yet does not understand the content at the point of (2). The viewer A is not interested in the content of the conference, yet feels comfortable and understands the content at the point of (3). The viewer A is excited at the point of (4). It is thus possible to know at what point each of the viewers is interested in the content of the conference, and accordingly it is possible to let the viewer manage the work related to the content in which the viewer is interested.

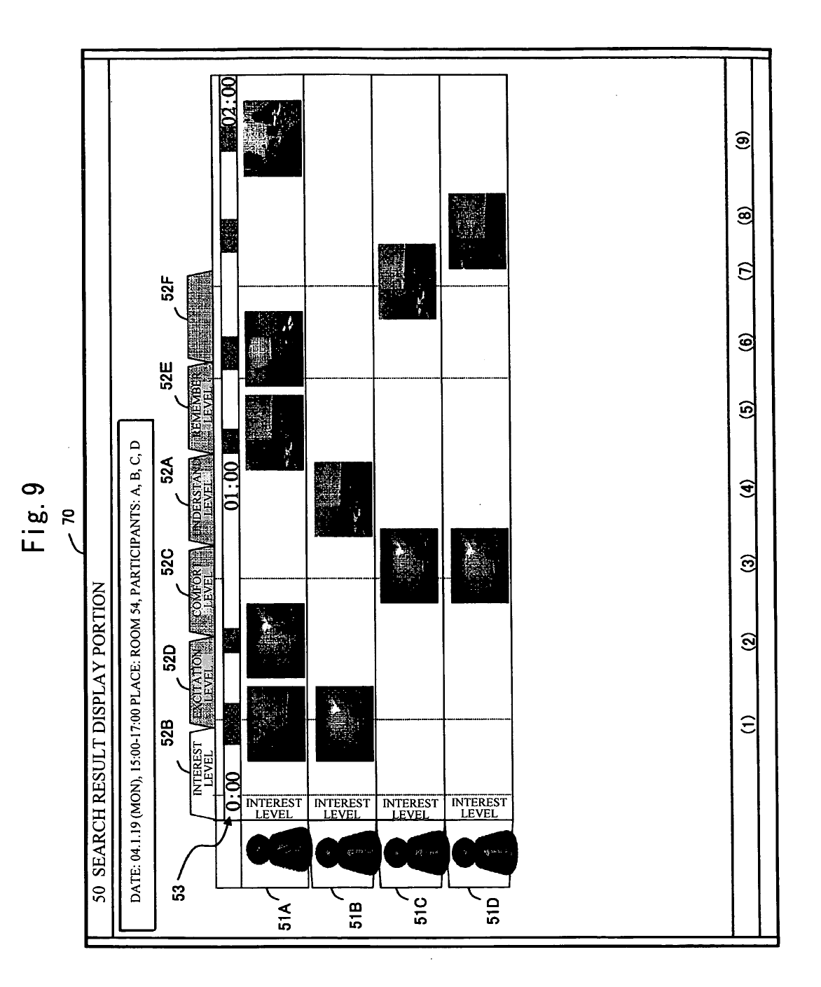

Next, a description will be given of another display example. FIG. 9 shows another display example. Referring to FIG. 9, the display controller 15 displays a graphical user interface 70 including the search result display portion 50. The display controller 15 displays the thumbnails on the search result display portion 50 in table format. The search result display portion 50 shows a list of the thumbnails related to the understand level of all the viewers A through D included in the conference image information. The display controller 15 displays viewer tabs 51A through 51D on the search result display portion 50 to show the thumbnails for each person. The display controller 15 displays the status tabs 52A through 52F to show the thumbnails for each state of mind. The display controller 15 also displays the timeline slider 53 in the search result display portion 50.

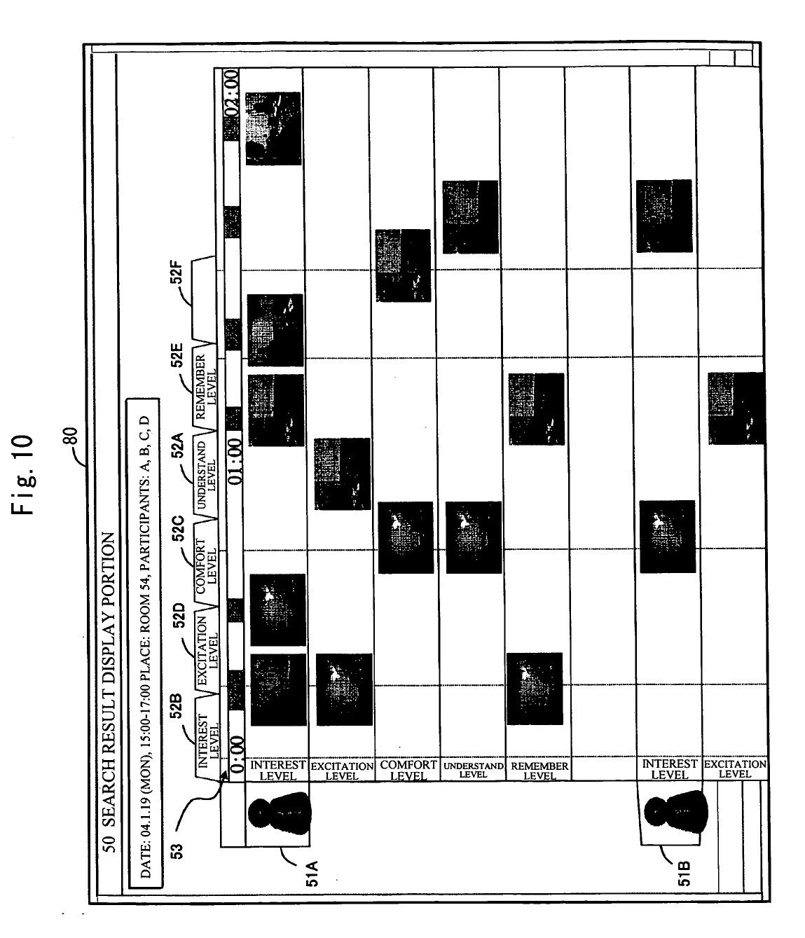

Next, a description will be given of further another display example. FIG. 10 shows another display example. The display controller 15 displays a graphical user interface 80 including the search result display portion 50. The display controller 15 displays the thumbnails on the search result display portion 50 in table format. The display controller 15 displays the viewer tabs 51A and 51B on the search result display portion 50 to show the thumbnails of the states of mind for the each person. Further, the display controller 15 displays the status tabs 52A through 52F to show the thumbnails for each state of mind.

The search result display portion 50 displays the thumbnails related to the interest level, the excitation level, the comfort level, the understand level, and the remember level for all the viewers at a time. Here, only the thumbnails related to the viewers A and B are shown in the drawing. However, the thumbnails of the all the viewers can be displayed by scrolling the screen.

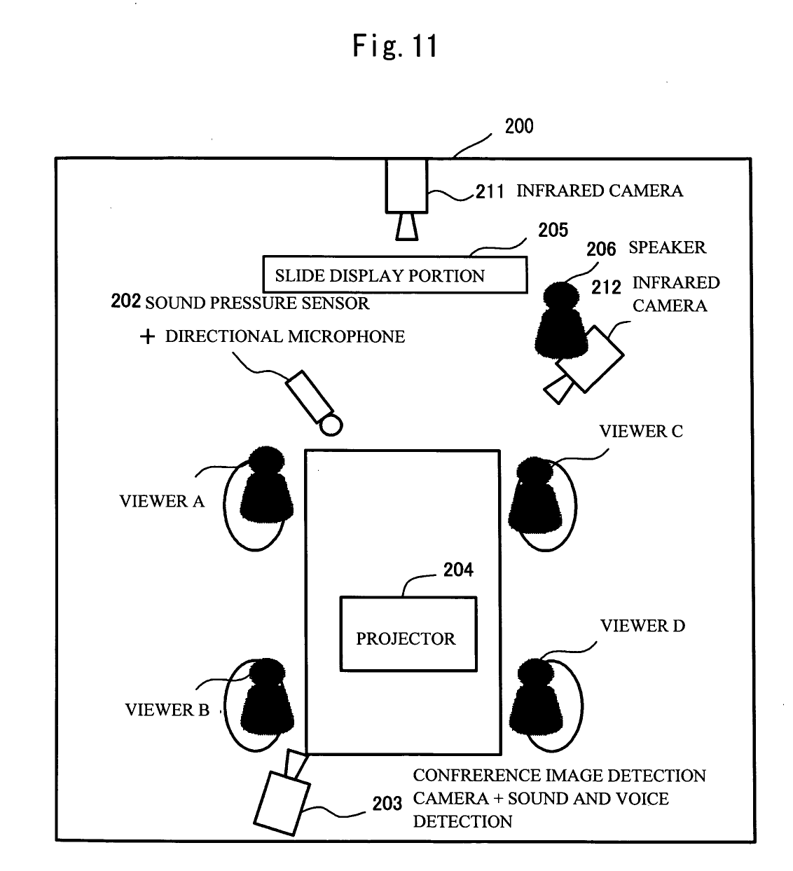

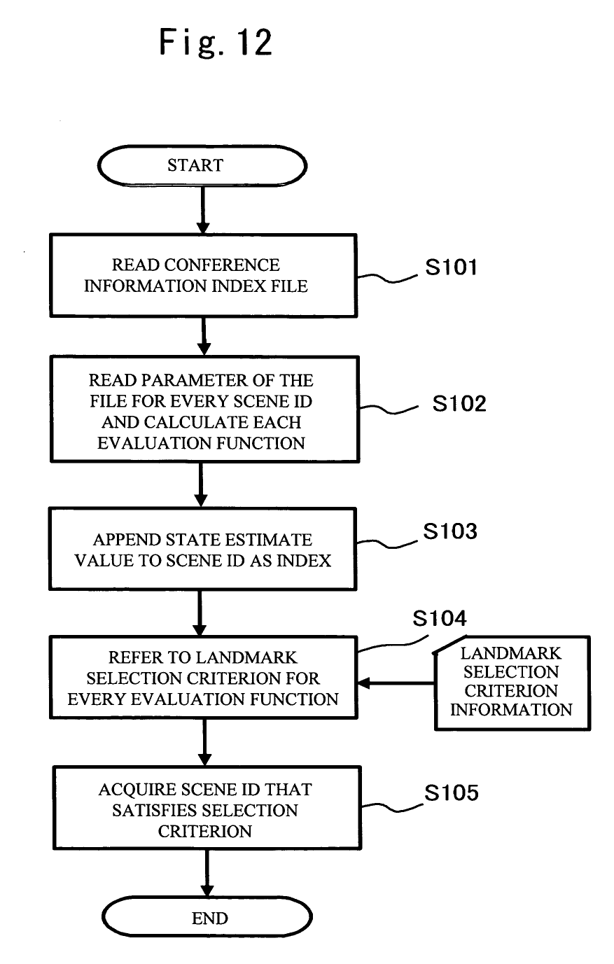

Next, a description will be given of the operation of the information processing system 1. FIG. 11 is a view illustrating how to detect and store the living body information, the sound information, and the conference image information. A reference numeral 200 denotes a conference room. FIG. 12 is a flowchart showing the landmark scene selection process. Referring to FIG. 11, the living body information detection portion 2 is composed of infrared cameras 211 and 212. The infrared camera 211 senses the images of eyes of the viewer A, when the viewer A looks at a slide display portion 205. The infrared camera 212 takes a gazing state of a speaker 206. The sound information detection portion 3 is composed of a sound pressure sensor and a directional microphone 202. The conference image detection portion 4 is composed of a conference image detection camera 203. The synchronizer 8 synchronizes the living body information and the sound information with the conference image information, and stores in the conference information storage portion 9 as an index file.

The state estimate processor 10 reads out the conference information index file in the conference information storage portion 9 in step S101 shown in FIG. 12. In step S102, the state estimate processor 10 reads out the information included in the conference information index file provided for every scene ID as a parameter, calculates the above-mentioned evaluation function, and estimates the state estimate value of the person. The state level determination portion 11 ranks the states of mind of the viewer. In step S103, the state estimate values estimated by the state estimate processor 10 and the ranks of the states of mind judged by the state level determination portion 11 are associated with the conference image information data ID, and are stored in the index file storage portion 12 as indexes. The state rank judgment process may be performed selectively.

The user designates a specific viewer from the search request input portion 13, and inputs the state that the viewer has interest and information on a landmark selection criterion. The display controller 15 refers to the landmark selection criterion for every evaluation function in step S104, and acquires a scene ID that satisfies the landmark selection criterion in step S105. The display controller 15 refers to the conference image storage portion 7 to acquire the conference image information corresponding to the conference image information data ID from the conference image storage portion 7, creates the thumbnails, and performs the display process as shown in FIGS. 7 through 10. This allows the user who is looking at the displayed information to review the desired scene effectively.

Next, a description will be given of a second embodiment. In the above-mentioned first embodiment, the living body information and the like of the conference viewers or participants is obtained, the states of mind based on the information are estimated and displayed, and the moving image to be played is accessed. In addition, the information processing system 1 in accordance with the first embodiment estimates the states of mind of the conference participant with the living body information and displays the estimated states of mind of the conference participant. Assuming that a user remembers that one of the conference participants was significantly nodding although the participant did not understand. When the user tries to find “the scene that was highly understood by the participant” after the conference, there is possibility that the scene cannot be found. This is because the scene is defined, as a low understand level. This drawback is solved in the second embodiment.

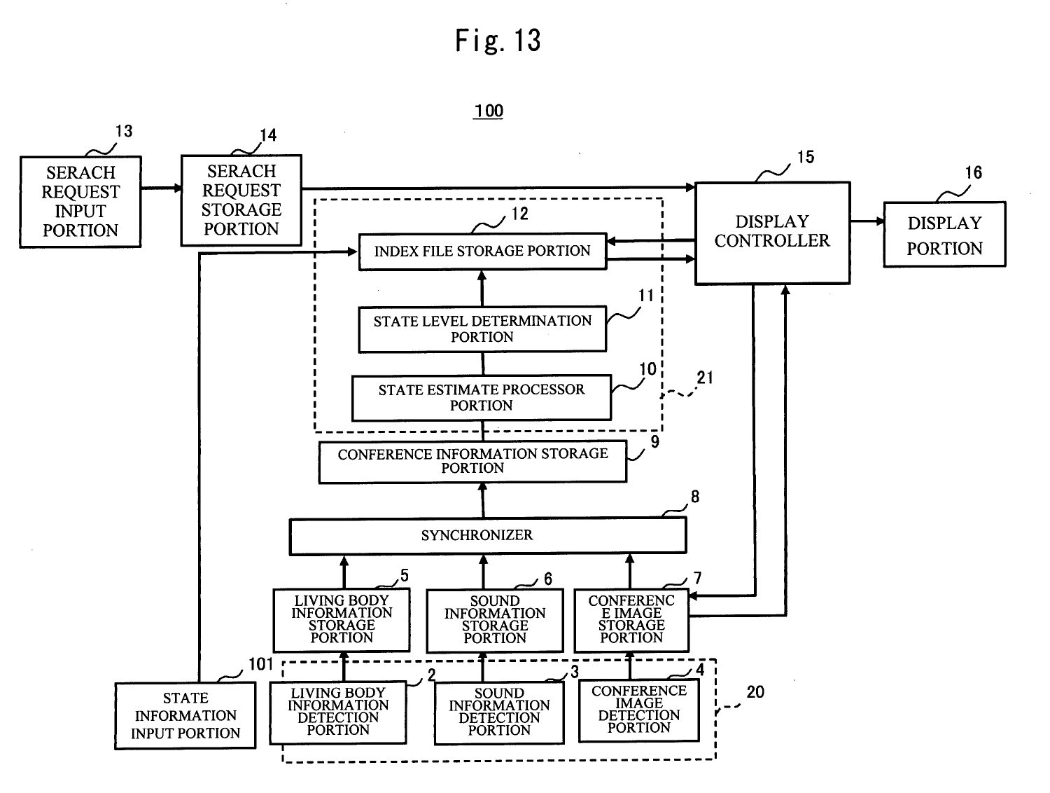

FIG. 13 is a block diagram of an information processing system 100 of the second embodiment. As shown in FIG. 13, the information processing system 100 includes the living body information detection portion 2, the sound information detection portion 3, the conference image detection portion 4, the living body information storage portion 5, the sound information storage portion 6, the conference image storage portion 7, the synchronizer 8, the conference information storage portion 9, the state estimate processor 10, the state level determination portion 11, the index file storage portion 12, the search request input portion 13, the search request storage portion 14, the display controller 15, the display portion 16, and a state information input portion 101. The living body information detection portion 2, the sound information detection portion 3, and the conference image detection portion 4 serve as a conference information detection portion 20. The state estimate processor 10, the state level determination portion 11, and the index file storage portion 12 serve as a landmark selection processor 21 that performs selection process of the landmark.

The state information input portion 101 is provided so that the user may manually input the states of mind of the conference participants. In the present embodiment, the state information input portion 101 is realized with the graphical user interface having buttons and sliders. The user is able to input the states of mind of the conference participants into the graphical user interface provided by the state information input portion 101 with the use of, for example, the touch panel, mouse, or key board. With the state information input portion 101, the user is able to designate a specific viewer, for example, and further input the viewer's states of mind such as the interest level of the viewer on the basis of the user's intention. The states of mind of the conference viewer thus input by the state information input portion 101 are stored in the index file storage portion 12. The index file storage portion 12 separately stores the states of mind of the conference viewer that has been estimated by the state estimate processor 10 and the states of mind of the conference viewer that has been input by the state information input portion 101.

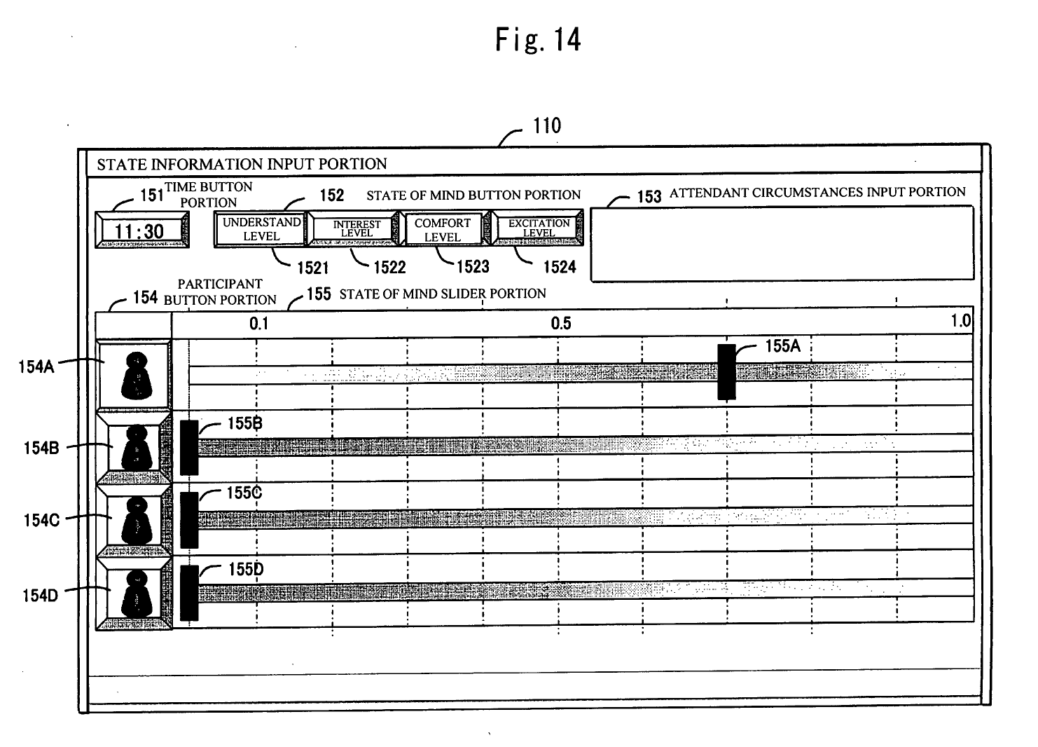

FIG. 14 shows a graphical user interface 110 having the buttons and the sliders added thereto. As shown in FIG. 14, the state information input portion 101 displays a time button portion 151, a state of mind button portion 152, an attendant circumstance input portion 153, a participant button portion 154, and a state of mind slider portion 155 inside the graphical user interface 110. The state of mind button portion 152 includes an understand level button 1521, an interest level button 1522, a comfort level button 1523, and an excitation level button 1524. The states of mind of the viewer A are shown in FIG. 14. First, a participant button portion 154A is clicked to designate the viewer A. Then, the understand level button 1521 is clicked to designate the state of mind button portion 152. A numeric value can be given to a slider bar 155A of the state of mind slider portion 155 to record the states of mind in more detail. Additionally, the time button portion 151 shows the time synchronized with a computer, and only a click can give a time stamp. Text can be entered into the attendant circumstance input portion 153 according to the circumstances as necessary.

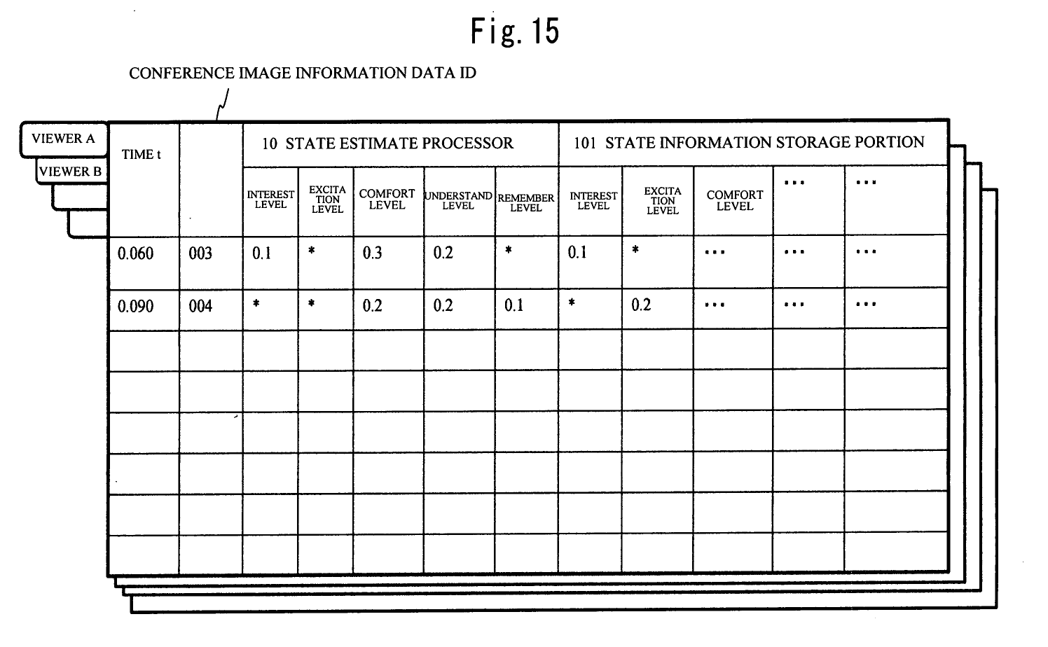

FIG. 15 shows the index file in the index file storage portion 12. As shown in FIG. 15, there are provided, from the left, the time t and the conference image information ID, and the items representing the viewer's states of mind estimated by the state estimate processor 10 such as the interest level, the excitation level, the comfort level, the understand level, and the remember level, and the items representing the viewer's states of mind estimated by the state information input portion 101 such as the interest level, the excitation level, the comfort level, the understand level, and the remember level. The times corresponding to the conference image information are respectively input in the column of the time t. The number that identifies the conference image information is input into the conference image information ID. The state estimate values that have been obtained by the above-mentioned evaluation function are input into the respective cells of the viewer's states of mind estimated by the state estimate processor 10 such as the interest level, the excitation level, the comfort level, the understand level, and the remember level. The scene having the * marks denotes the scenes deleted by the state level determination portion 11 in the drawing. This reduces the number of the scenes to be searched.

Here, the aforementioned drawing shows the interest level, the excitation level, the comfort level, the understand level, and the remember level as the viewer's states of mind. However, the viewer's states of mind may not be limited to the above-mentioned levels. The state estimate values that have been obtained by the above-mentioned evaluation function are input into the respective cells of the viewer's states of mind acquired by state information input portion 101 such as the interest level, the excitation level, the comfort level, the understand level, and the remember level. The input values may have 10 levels to 1 at the intervals of 0.1, yet may have other variations.

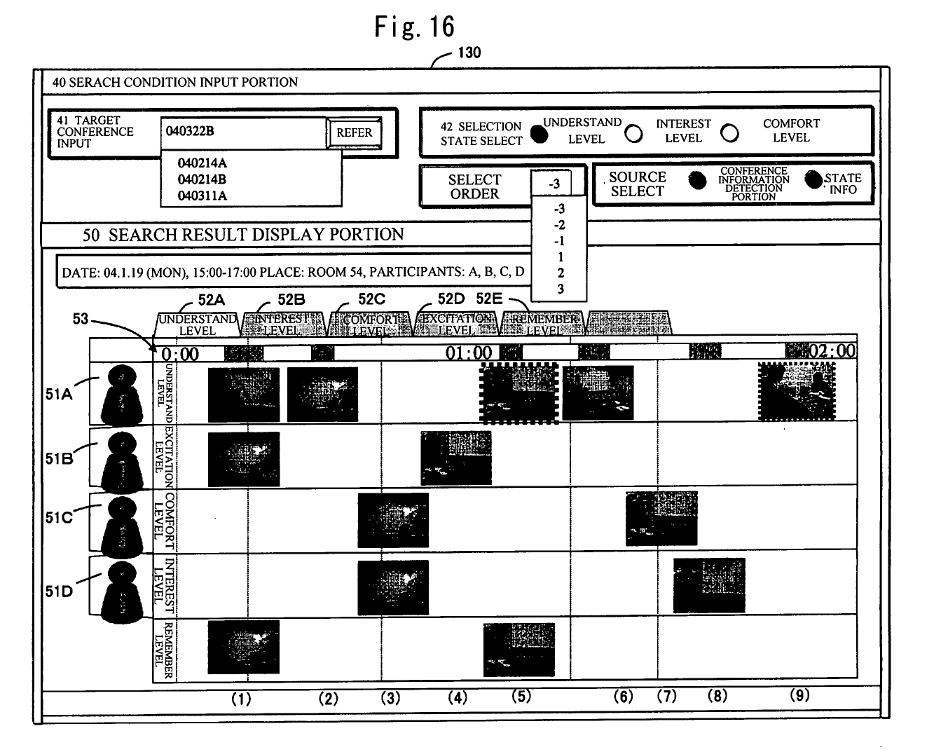

FIG. 16 is shows another display example. Referring to FIG. 16, the display controller 15 displays a graphical user interface 130 including the search condition input portion 40 and the search result display portion 50. The search condition input portion 40 includes the target conference input portion 41, the selection state select portion 42, the selection order select portion 43, and a source select portion 44. The search request can be input from the search condition input portion 13. Arbitrary conference image can be selected from the target conference input portion 41. The states of mind of the viewer can be selected from the selection state select portion 42. Here, FIG. 16 shows only the understand level and the comfort level from among the states of mind of the viewer. The selection order select portion 43 determines the number of the scenes selected by the state level determination portion 11.

The search result display portion 50 displays the thumbnails in table format. The search result display portion 50 is capable of displaying the thumbnails for every viewer included in the conference image information. The example shown in FIG. 16 displays the thumbnails on the basis of the states of mind of the viewer A. The search result display portion 50 displays the viewer tabs 51A through 51D to show the thumbnails for every person. The search result display portion 50 also displays the status tabs 52A through 52F to show the thumbnails for each state of mind of the viewer. This makes it possible to view landmark slides related to all states of mind of, for example, the viewer A.

The display controller 15 is capable of visualizing the difference with different colors in the display format showing the thumbnails. The thumbnail extracted by the state estimate processor 10 is outlined with a colorless frame as shown in (1) in FIG. 16, and the thumbnail input by the state information input portion 101 is outlined with a blue frame as shown in (5) in FIG. 16. Moreover, the thumbnail extracted by the state estimate processor 10 equal to the thumbnail input by the state information input portion 101 is outlined with a red frame as shown in (9) in FIG. 16. This enables to display the thumbnail of the scene (5) as “the scene that the viewer A understood”, because the user thinks that the viewer A understood in the scene (5), whereas in fact the viewer A did not understand. Further, one of the output of the state estimate processor 10 and the output of the state information input portion 101 can be selectively displayed.

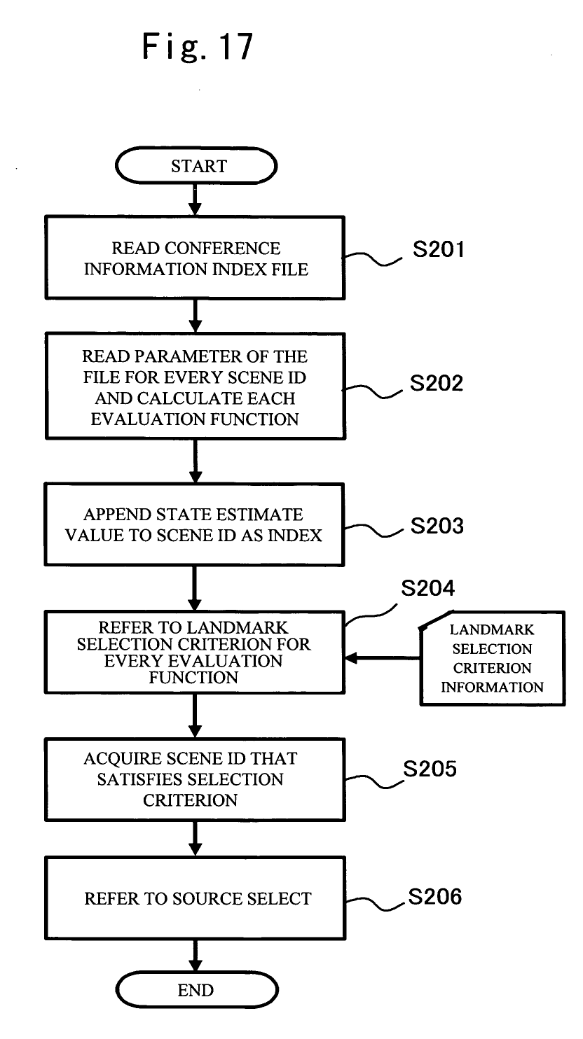

FIG. 17 is a flowchart showing a landmark scene selection process of the second embodiment. The state estimate processor 10 reads out the conference information index file in the conference information storage portion 9 in step S201. Instep S202, the state estimate processor 10 reads out the information included in the conference information index file provided for every scene ID as a parameter, calculates the above-mentioned evaluation function, and estimates the state estimate value of the person. The state level determination portion 11 ranks the states of mind of the viewer. The state level determination portion 11 ranks the states of mind of the viewer. In step S103, the state estimate values estimated by the state estimate processor 10 and the ranks of the states of mind judged by the state level determination portion 11 are associated with the conference image information data ID, and are stored in the index file storage portion 12 as indexes. The state rank judgment process may be performed selectively.

The user designates a specific viewer from the search request input portion 13, and inputs the state that the viewer has interest and information on a landmark selection criterion. The landmark selection criterion can be changed by the selection order select portion 43 in the search condition input portion 40 shown in FIG. 16. This change can be performed with the search request input portion 13. The display controller 15 refers to the landmark selection criterion for every evaluation function, and acquires the scene ID that satisfies the landmark selection criterion in step S205. In step S206, the display controller 15 refers to the source selection and is set to display the thumbnails on the select condition. The display controller 15 refers to the conference image storage portion 7, acquires the conference image information corresponding to the conference image information data ID, generates the thumbnail, and performs the display process shown in FIG. 16. This allows the person who views the display to review the desired scene effectively.

According to the embodiments described above, the states of the viewer can be given with the living body information as the clue of the scene to be searched, and the scene matched with the clue can be searched. This can specify the desired scene from among the scenes segmented at certain intervals. This can also specify a meaningful scene for the viewer who did not say a word, even if the importance is specified with the voice volume of the speaker. It is also possible to associate the desired scene with each of the viewers. The search operation can be supported to search the moving image data for the desired scene recorded the conference or presentation held in the conference room. Moreover, with the above-mentioned embodiments, it is possible to support the search for the desired scene. It is therefore possible to the review the scene desired by the viewer effectively.

An information processing method of the present invention may be realized by a CPU (Central Processing Unit), a ROM (Read Only Memory), and a RAM (Random Access Memory). A program thereof is installed from a portable storage medium such as CD-ROM, DVD, a flexible disc, or is downloaded by way of a communication line. When the CPU executes the program, each step is accomplished. That is to say, the program makes the computer execute the steps of estimating the states of mind of the person with at least one of the living body information and the sound information acquired when the person was captured, and makes the computer execute the steps of providing the image information with the index at the time of capturing.

Although a few embodiments of the present invention have been shown and described, it would be appreciated by those skilled in the art that changes may be made in these embodiments without departing from the principles and spirit of the invention, the scope of which is defined in the claims and their equivalents. For example, the conference image has been described as the image in the above-mentioned embodiments, however, the image of the present invention may not be limited to the conference image.

The present invention includes the following configuration. The information processing apparatus of the present invention further includes a determination portion that determines priority levels in the states of mind of the person estimated by the estimate portion. According to the present invention, the priority levels are capable of making appropriate scenes as landmarks, thereby preventing the search performance from drastically degrading owing to the enormous numbers of items to be searched.

The states of mind of the person comprises at least one of an interest level of the person, an excitation level of the person, a comfort level of the person, an understand level of the person, a remember level of the person, a concentration level of the person, a support level that represents a degree to which the person agrees with the other's opinion, a shared feeling level that represents the degree to which the person feels and understands the other's opinion in a same manner, a subjectivity level that represents the degree to which the person evaluates on the basis of subjectivity of the person, an objectivity level that represents the degree to which the person shows universal points of view, being independent of a specific, personal, and subjective way of thinking, a dislike level that represents the degree to which the person's mind has a negative feeling, and a fatigue level that represents the degree to which the person is tired. The estimate portion estimates the states of mind of the person with a given evaluation function. The living body information and the sound information of the person are weighted and added. The information processing apparatus of the present invention further includes a synchronizer that synchronizes the living information and the sound information of the person with the image information. The information processing apparatus of the present invention further includes a storage portion that stores the information synchronized in the synchronizer; and another storage portion that stores image information to which the index is appended. The information processing apparatus of the present invention further includes a memory portion that stores the index appended by the append portion, the index being associated with time information of the image information. The information processing apparatus of the present invention further includes a display controller that refers to the index appended by the append portion and displays the image information in a given format. The display controller displays the image information for every person included in the image information. The display controller displays a select portion to show the image information for said every person. The display controller displays the image information on the basis of the states of mind of the person. The display controller adds and displays a given timeline slider. The timeline sliders allows to segment the time at short intervals. The display controller displays the image information with a thumbnail. The display controller plays the image information that corresponds to a selected thumbnail. The living body information of the person includes at least one of information on pupil diameters, a target being gazed at, a gazing period, a blink, and a temperature on skin of face. The sound information includes at least one of information on whether or not there is a remark, a sound volume, whether or not a speaker makes a remark, a voice volume of the speaker, and an environmental sound. The image is a conference image. The information processing apparatus of the present invention further includes a living body information detection portion that detects the living body information of the person; a sound information detection portion that detects the sound information at the time of capturing; and a capturing portion that captures the image information. The living body information detection portion detects a blink of the person and a state of the person's eye as the living body information of the person. The living body information detection portion detects a temperature on skin of face.

1. An information processing apparatus comprising:
an estimate portion that estimates states of mind of a person with either or both of living body information and sound information of the person acquired at a time of capturing the person; and
an append portion that appends an index to image information acquired at the time of capturing the person with the states of mind of the person estimated by the estimate portion.

2. The information processing apparatus according to claim 1, further comprising a determination portion that determines priority levels in the states of mind of the person estimated by the estimate portion.

3. The information processing apparatus according to claim 1, wherein the states of mind of the person comprises at least one of an interest level of the person, an excitation level of the person, a comfort level of the person, an understand level of the person, a remember level of the person, a concentration level of the person, a support level that represents a degree to which the person agrees with the other's opinion, a shared feeling level that represents the degree to which the person feels and understands the other's opinion in a same manner, a subjectivity level that represents the degree to which the person evaluates on the basis of subjectivity of the person, an objectivity level that represents the degree to which the person shows universal points of view, being independent of a specific, personal, and subjective way of thinking, a dislike level that represents the degree to which the person's mind has a negative feeling, and a fatigue level that represents the degree to which the person is tired.

4. The information processing apparatus according to claim 1, wherein the estimate portion estimates the states of mind of the person with a given evaluation function.

5. The information processing apparatus according to claim 4, wherein the living body information and the sound information of the person are weighted and added.

6. The information processing apparatus according to claim 1, further comprising a synchronizer that synchronizes the living information and the sound information of the person with the image information.

7. The information processing apparatus according to claim 6, further comprising:
a storage portion that stores the information synchronized in the synchronizer; and
another storage portion that stores image information to which the index is appended.

8. The information processing apparatus according to claim 1, further comprising a memory portion that stores the index appended by the append portion, the index being associated with time information of the image information.

9. The information processing apparatus according to claim 1, further comprising a display controller that refers to the index appended by the append portion and displays the image information in a given format.

10. The information processing apparatus according to claim 9, wherein the display controller displays the image information for every person included in the image information.

11. The information processing apparatus according to claim 9, wherein the display controller displays a select portion to show the image information for said every person.

12. The information processing apparatus according to claim 9, wherein the display controller displays the image information on the basis of the states of mind of the person.

13. The information processing apparatus according to claim 9, wherein the display controller adds and displays a given timeline slider.

14. The information processing apparatus according to claim 9, wherein the display controller displays the image information with a thumbnail.

15. The information processing apparatus according to claim 9, wherein the display controller plays the image information that corresponds to a selected thumbnail.

16. The information processing apparatus according to claim 1, wherein the living body information of the person includes at least one of information on pupil diameters, a target being gazed at, a gazing period, a blink, and a temperature on skin of face.

17. The information processing apparatus according to claim 1, wherein the sound information includes at least one of information on whether or not there is a remark, a sound volume, whether or not a speaker makes a remark, a voice volume of the speaker, and an environmental sound.

18. The information processing apparatus according to claim 1, wherein the image is a conference image.

19. The information processing apparatus according to claim 1, further comprising:
a living body information detection portion that detects the living body information of the person;
a sound information detection portion that detects the sound information at the time of capturing; and
a capturing portion that captures the image information.

20. The information processing apparatus according to claim 19, wherein the living body information detection portion detects a blink of the person and a state of the person's eye as the living body information of the person.

21. The information processing apparatus according to claim 19, wherein the living body information detection portion detects a temperature on skin of face.

22. An information processing method comprising:
estimating states of mind of a person with either or both of living body information and sound information of the person acquired at a time of capturing the person; and
appending an index to image information acquired at the time of capturing the person with the states of mind of the person estimated by the estimate portion.

23. The information processing method according to claim 22, wherein the states of mind of the person comprises at least one of an interest level of the person, an excitation level of the person, a comfort level of the person, an understand level of the person, a remember level of the person, a concentration level of the person, a support level that represents a degree to which the person agrees with the other's opinion, a shared feeling level that represents the degree to which the person feels and understands the other's opinion in a same manner, a subjectivity level that represents the degree to which the person evaluates on the basis of subjectivity of the person, an objectivity level that represents the degree to which the person shows universal points of view, being independent of a specific, personal, and subjective way of thinking, a dislike level that represents the degree to which the person's mind has a negative feeling, and a fatigue level that represents the degree to which the person is tired.

24. The information processing apparatus according to claim 22, wherein the estimate portion estimates the states of mind of the person with a given evaluation function.
